(19) United States
(12) Patent Application Publication
(10) Pub. No.: US 2006/0214817 A1
(43) Pub. Date: Sep. 28, 2006

(54) Method and assembly, in addition to computer program comprising program-code means and computer-program product for determining maneuver information from a record of predeterminable maneuver information for a mobile unit fuzzy logic

(76) Inventors: Martin Appl, Muenchen (DE); Martin Hartmann, Dillenburg (DE); Kai Heesche, Munchen (DE); Henning Lenz, Munchen (DE); Wolfgang Mayer, Amberg (DE); Torsten Mosis, Freising (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/497,941

(22) PCT Filed: Dec. 3, 2002
(86) PCT No.: PCT/DE02/04421

§ 371 Date: Nov. 22, 2004

(30) Foreign Application Priority Data
Dec. 6, 2001 (DE) 101 59 872.6

(51) Int. Cl. G01C 22/00

(52) U.S. Cl. 340/995.19; 701/23; 701/207

(57) ABSTRACT

According to the invention, primary route information, which describes a primary route of a mobile unit, is determined for said mobile unit. The primary route information is then evaluated using fuzzy logic, determining the maneuver information.

The invention relates to determining maneuver information from a record of predeterminable maneuver information for a mobile unit.

Such a determination of a maneuver information item for a mobile unit, for example for a motor vehicle, is generally termed maneuver generation and in this case used in a motor vehicle navigation system.

A motor vehicle navigation system with such maneuver generation is known from [1].

This motor vehicle navigation system comprises various modules, a first for position determination, a second module for route planning and a third module for maneuver generation.

In the determination of a position by the first module, a current, actually occupied position of the motor vehicle is determined, a corresponding map position is determined in a digital map, which map position matches the actual position of the motor vehicle (map matching) and a section of the digital map with the determined map position is displayed to a driver of the motor vehicle.

Screens, monitors or displays, for example, are used as display systems.

Map matching methods are known from [2] and [3].

In the planning of a route by the second module, a route is planned or determined for a starting point of the motor vehicle and for a destination point of the motor vehicle, which route connects the starting point with the destination point in a suitable manner, for example via a shortest path. The planned or determined route is also displayed on the digital map to the driver of the motor vehicle.

In the generation of a maneuver by the third module, instructions for the driver, known as maneuver instructions or maneuver information, are determined, which guide the driver along the planned route to the destination point.

The maneuver instructions, for example an instruction to drive straight ahead (Straight, S), an instruction to turn left (Left, L) or right (Right, R) or an instruction to make a U-turn (U-Turn, U), are optically displayed to the driver during his/her journey as selected points on the route are reached, for example by means of a visual output in the form of arrows or bar charts on a screen, as in the case of the motor vehicle navigation system known from [1], and communicated acoustically, for example by means of a voice output.

These maneuver instructions provide valuable information and guidance for the driver, in particular at route intersections on the planned route, at which intersections normally several alternative routes meet and are possible for continuing the journey. A maneuver information item indicates to the driver the correct onward route from the several alternative routes.

In the determination of a maneuver information item, a change in the direction of the onward course of the route is determined in the motor vehicle navigation system known from [1] at such a selected point on the route, described by a corresponding change of angle of the route.

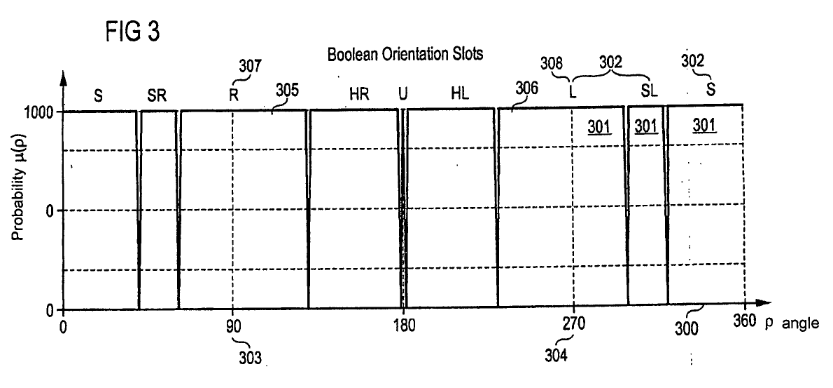

For this change of angle, the relevant maneuver information item, for example (Straight, S), (Left, L), (Right, R) or (U-Turn, U) is determined (FIG. 3, 302). To this end, all possible changes of angle 300, i.e. changes of angle from 0° to 360°, are subdivided into fixed angle ranges 301, known as angle windows 301. A maneuver information item 302 is unambiguously assigned to each angle window 301.

If a change of angle of the onward route is determined, then the corresponding angle window is specified for this change of angle and the relevant maneuver information determined for this angle window.

Thus, for example, a change of angle 303 or 304 of the route of 90° or of −90° (=270°) lies in the angle window 60° to 120° 305 or in the angle window 240° to 300° 306 and leads to a maneuver information item “R” 307 or “L” 308.

The assignments “changes of angle 300 to maneuver information 302” or the angle windows 301 for the maneuver information items 302 “S”, “L”, “R” and “U” are shown in FIG. 3.

Fundamental principles of a fuzzy logic are known from [4].

The procedure for maneuver generation known from [1] has, however, the disadvantage that in many cases, particularly where there are complex route intersections with multiple possible alternative routes, each of which exhibits similar changes of angle, no clear maneuver information in respect of the correct onward route is generated for the driver.

Consequently, the object of the invention is to indicate a method for determining maneuver information for a mobile unit, which method generates for the driver clearer maneuver information than that which is generated in the case of the motor vehicle navigation system described.

The object is achieved in the method and the arrangement as well as in the computer program comprising program-code means and the computer-program product for determining maneuver information from a record of predeterminable maneuver information for a mobile unit using fuzzy logic, comprising in each case the features according to the respective independent claim.

In the method for determining maneuver information from a record of predeterminable maneuver information for a mobile unit using fuzzy logic, primary route information, which describes a primary route of the mobile unit, is determined. The primary route information is then evaluated using fuzzy logic, whereby a maneuver information item is determined.

In the fuzzy evaluation, first memberships are determined for the primary route information using fuzzy membership functions, with which first memberships the membership of the primary route information of one of the predeterminable maneuver information items is described in each case. Furthermore, the first memberships are evaluated using rules, whereby a maneuver information item is determined.

In a further method according to the invention for determining maneuver information from a record of predeterminable maneuver information for a mobile unit using fuzzy logic, primary route information, which describes a primary route of the mobile unit, and at least one secondary route information item, which describes an alternative route to the primary route of the mobile unit, are determined.

The primary route information and the secondary route information are evaluated using fuzzy logic, whereby the maneuver information item is determined.

In the fuzzy evaluation, first memberships are determined for the primary route information using fuzzy membership functions, with which first memberships the membership of the primary route information of one of the predeterminable maneuver information items is described in each case. Second memberships are determined for the secondary route information using fuzzy membership functions, with which second memberships the membership of the secondary route information of one of the predeterminable maneuver information items is described in each case.

The first and the second memberships are evaluated using fuzzy rules, whereby a maneuver information item is determined.

The arrangement for determining maneuver information from a set of predeterminable maneuver information for a mobile unit using fuzzy logic has a processor which is set up to implement the following steps:
wherein primary route information, which describes a primary route of the mobile unit, and at least one secondary route information item, which describes an alternative route to the primary route of the mobile unit, are determined,
wherein the primary route information and the secondary route information are evaluated using fuzzy logic, whereby a maneuver information item is determined such that
a) first memberships are determined for the primary route information using fuzzy membership functions, with which first memberships the membership of the primary route information of one of the predeterminable maneuver information items is described in each case,
b) second memberships are determined for the secondary route information using the fuzzy membership functions, with which second memberships the membership of the secondary route information of one of the predeterminable maneuver information items is described in each case, and
c) the first and the second memberships are evaluated using fuzzy rules, whereby the maneuver information item is determined.

According to the invention the primary route information is deemed to be information which describes a route to be covered by the mobile unit. The secondary route information is deemed to be information which describes a route which can be covered as an alternative to the route to be covered.

The computer program with program-code means is set up in order to implement all the steps according to the respective method according to the invention if the program is executed on a computer.

The computer-program product with program-code means stored on a machine-readable medium is set up in order to implement all the steps according to the inventive method if the program is executed on a computer.

The arrangement and the computer program with program-code means, set up in order to implement all the steps according to the respective inventive method if the program is executed on a computer, and the computer-program product with program-code means stored on a machine-readable medium, set up in order to implement all the steps according to the respective inventive method if the program is executed on a computer, are particularly suitable for implementing the method according to the invention or one of its developments explained hereinafter.

A key and advantageous aspect of the invention is the use of fuzzy logic in determining maneuver information or in maneuver generation. Through the use of fuzzy logic, the invention exhibits particular advantages.

In contrast to the “crisp” assignment of angle change to maneuver information known from [1], i.e. the “crisp” logic in maneuver generation, the approach of the invention based on fuzzy logic offers the advantage of making the membership of a set, i.e. the match of an angle change to a maneuver information item, mathematically describable by means of intermediate values between false (0) and true (1).

In order to represent a problem, in this case the determination of maneuver information, a qualitative description with fuzzy concepts of human thinking is used here in addition to a numerical or quantitative description by means of matches. These descriptions enable nonfuzzy/crisp and fuzzy data to be handled formally precisely.

In addition, where there is a change in fuzzy rules, linguistic variables or operators, the reference to an overall behavior is retained. Specific and individual adjustments to possibly changing boundary conditions can thus be made easily and flexibly.

Furthermore, fuzzy logic approximates to a linguistic mode of expression in humans, thus making possible maneuver information that is understandable overall.

Preferred developments of the invention will emerge from the dependent claims.

The developments described hereinafter relate both to the method and to the arrangement.

The invention and the developments described hereinafter can be implemented both in software and in hardware, for example, using a special electrical circuit.

Furthermore, an implementation of the invention or of a development described hereinafter is possible by means of a computer-readable storage medium on which the computer program with program-code means which executes the invention or development is stored.

The invention or every development described hereinafter can also be implemented by a computer-program product which has a storage medium on which the computer program with program-code means which executes the invention or development is stored.

It is useful to describe the primary route information and/or the secondary route information by a change of direction, in particular by an angle of change of direction. Such a change of direction or such an angle can be determined in a simple manner, for example using a digital map with routes.

For outputting or communicating the maneuver information to a user, various output options are available, for example
an optical display of the determined maneuver information
an acoustic output of the determined maneuver information.

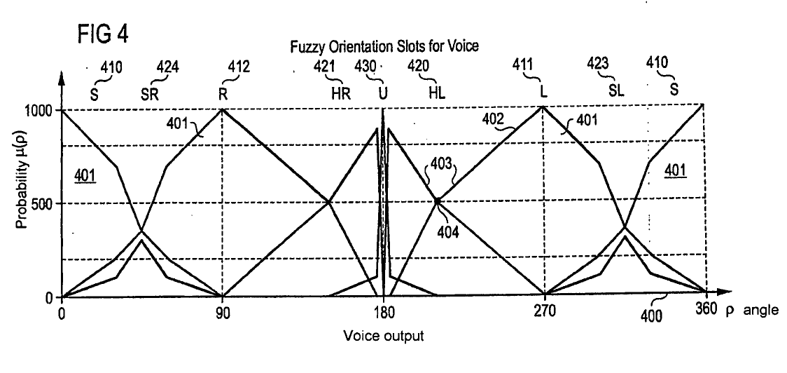

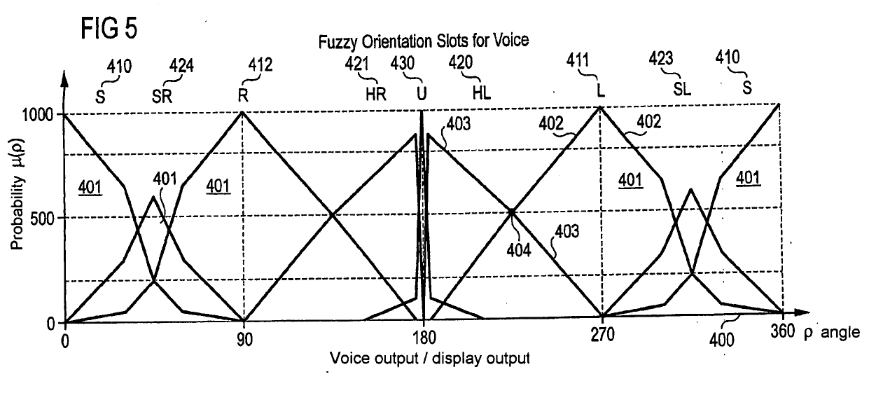

It is also possible to adapt the fuzzy membership functions and/or fuzzy rules to a type of output, for example the aforementioned optical or acoustic output of maneuver information. Thus, for example, for outputting maneuver information optically, different membership functions can be used from those used for an acoustic output (FIG. 4 and FIG. 5).

It is also useful when evaluating the route information using fuzzy logic to determine in respect of a maneuver information item a significance with which the maneuver information can be rated. This significance describes a certainty in respect of the respective maneuver information. Through such measures, clarity in the generation of maneuver information can be increased substantially.

It is also advantageous to code each of the first and/or second memberships, for example as bit-patterns. By this means, any storage space needed, in particular when implementing the invention on a computer, can be reduced and/or the execution of the invention on the computer speeded up.

From the fuzzy rules, significant, for example frequently used, fuzzy rules can be selected and compiled in a rule base.

By determining a performance value for a fuzzy rule with which a degree of performance of a rule result of the fuzzy rule is described, clarity in the generation of maneuvers can be further enhanced.

If such a performance value is determined for each of several fuzzy rules, these performance values can be combined to give an overall performance value. In this case maneuver information is determined using the overall performance value.

The invention is particularly suitable for use as part of a user-assistance program in mobile units, for example a navigation system for a motor vehicle. In this case, the mobile unit is the motor vehicle to be guided.

An embodiment of the invention, which will be explained in detail hereinbelow, is shown in the figures, in which

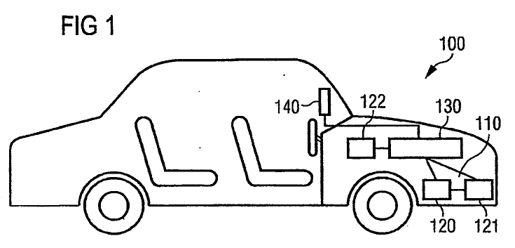

FIG. 1 shows a sketch of a navigation system with components in a motor vehicle according to an embodiment;

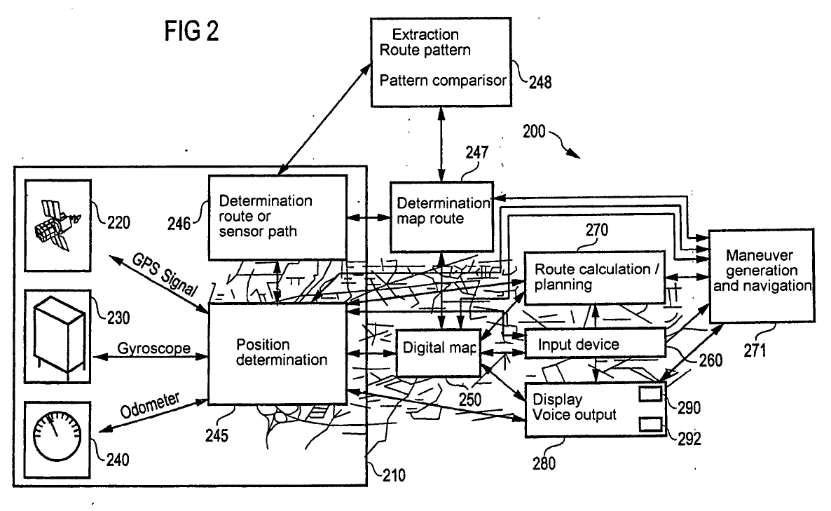

FIG. 2 shows a sketch which describes an interaction of components and their function in a navigation system according to an embodiment;

FIG. 3 shows a sketch which describes a “crisp” assignment of angle ranges to maneuver information according to an embodiment;

FIG. 4 shows a sketch which describes a “fuzzy” assignment of angle ranges to maneuver information for a voice output of maneuver information according to an embodiment;

FIG. 5 shows a sketch which describes a “fuzzy” assignment of angle ranges to maneuver information for an output of maneuver information to a display according to an embodiment;

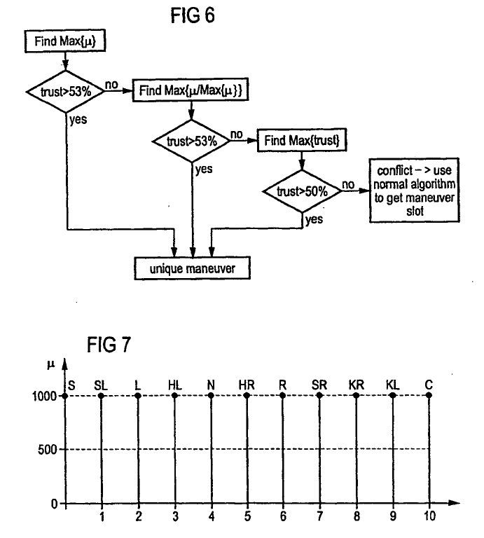

FIG. 6 shows a schematic representation of a procedure in determining maneuver information using a certainty according to an embodiment;

FIG. 7 shows a sketch comprising linguistic terms for a display output and a voice output of maneuver information according to an embodiment;

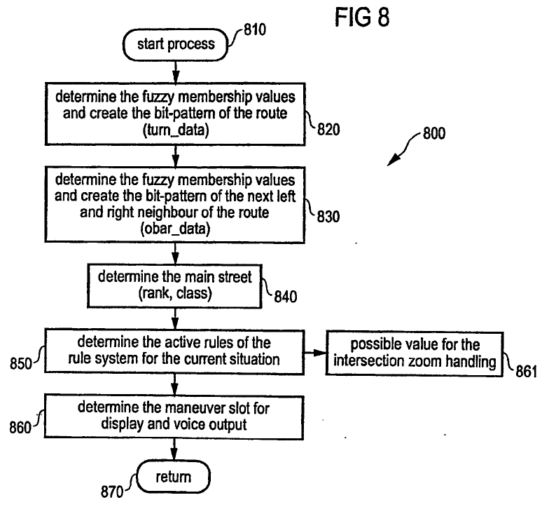

FIG. 8 shows a sketch comprising steps in generating a maneuver according to an embodiment;

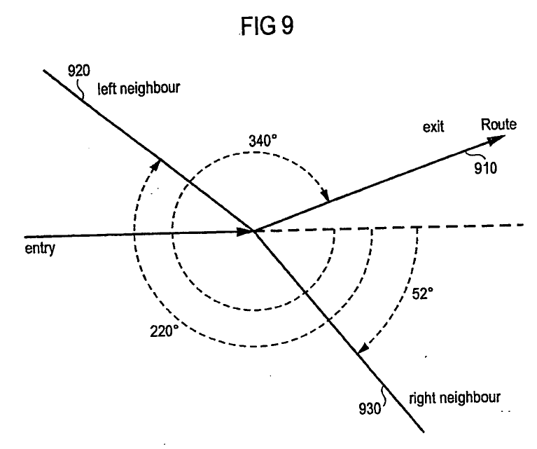

FIG. 9 shows a sketch of an intersection situation according to an embodiment;

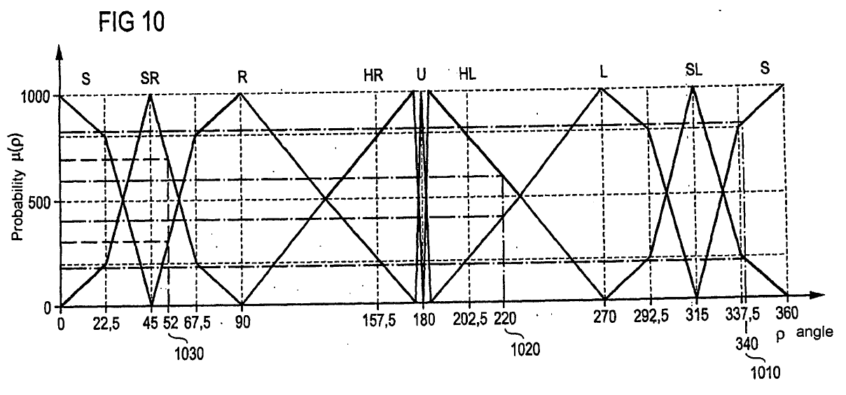

FIG. 10 shows a sketch which describes a “fuzzy” assignment of angle ranges to maneuver information for an output of maneuver information on a display and for a voice output according to an embodiment;

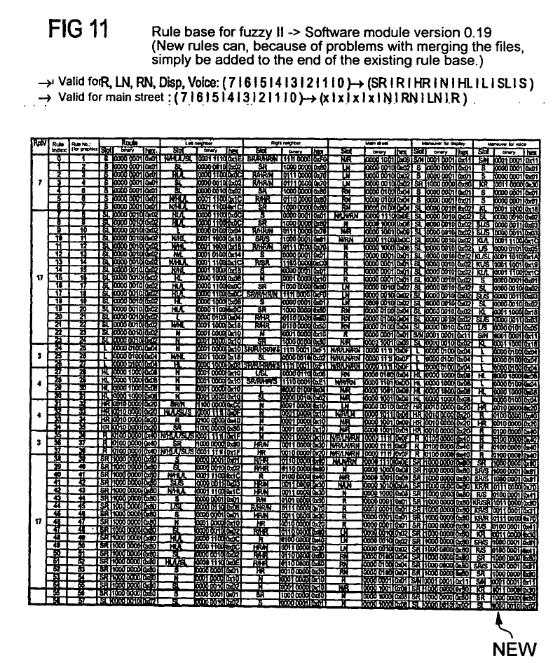

FIG. 11 shows a tabular overview (of an extract) of a rule base according to an embodiment;

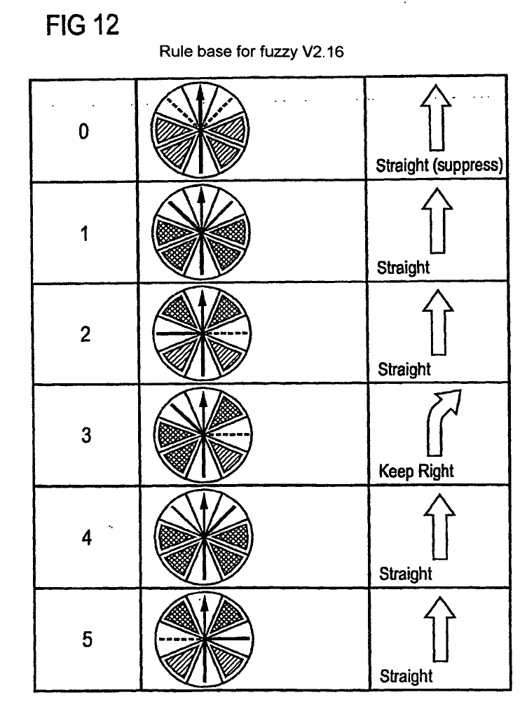

FIG. 12 shows a graphic representation (of an extract) of a rule base according to an embodiment;

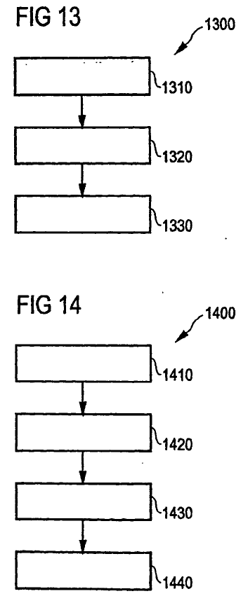

FIG. 13 shows process steps in generating a maneuver with fuzzy logic according to an embodiment;

FIG. 14 shows process steps in generating a maneuver with a rule-based fuzzy system according to an embodiment;

### EMBODIMENT: NAVIGATION SYSTEM IN A MOTOR VEHICLE

FIG. 1 shows a motor vehicle 100 which is fitted with a navigation system 110.

Components of this navigation system 110 are shown schematically and in their interaction in FIG. 1 and FIG. 2 and are described below.

The components of the navigation system 200 are each connected to one another with connections in such a way that data which is determined or measured in the individual components can be transmitted to the other components and be available there for further processing, for example by appropriately installed digital data processing means.

The connections between the components of the navigation system 200 are shown in FIG. 2 by arrows, the direction of an arrow signifying the direction of transmission of data between two components connected to one another.

The navigation system 200 combines various individual systems, a position-determining system 210, a system for route planning 270 and a system for maneuver generation and maneuver navigation 271.

Appropriate software programs for these systems 210, 270 and 271 and appropriate data for these systems, such as a digital map 250, are stored in an arithmetic-logic unit 130.

Position-Determining System

The position-determining system 210 of the navigation system 200 comprises three independent position-determining systems, a GPS system 220, a gyroscope 230 and an odometer 240.

FIG. 1 shows the gyroscope 120, the odometer 121 and the GPS 122, which are each connected via data lines 123 to the arithmetic-logic unit 130.

It should be pointed out that a data line can also be a radio path or another medium.

Using the gyroscope 230 and the odometer 240, a current, first item of position information of a current position of the motor vehicle is determined.

Using the GPS system 220, a second current position information item, redundant in relation to the first position information item, is determined.

Using the first and the redundant second position information items, an improved (because it is more accurate) current position information item is determined 245 for the current position of the motor vehicle 100.

Position determination 245 take place at regular, preset time intervals at preset times during a journey of the motor vehicle, as a result of which a route actually covered by the motor vehicle, a sensor path, is determined 246.

A digital map 250 is stored in the navigation system 200. The digital map 250 is a digitized image of surroundings of the motor vehicle 100 in which traffic connections and other traffic-relevant information, for example towns and their traffic networks, are entered.

The navigation system 200 also has a display unit 280 which comprises an optical output means 290 with an integrated acoustic output means 292 and on which the digital map 250 or relevant parts of the digital map 250 can be displayed.

The driver can in this way identify his/her current position as a current map position on the digital map 250 and follow or trace his/her route on the digital map.

Route planning, maneuver generation and maneuver navigation In addition, the navigation system 200 comprises the further systems 270, 271 for route planning and for maneuver generation and maneuver navigation.

These are connected to an input device 260 with which a destination position of the motor vehicle 100 can be input by a driver of the motor vehicle 100.

FIG. 1 shows the input means 140 for inputting the destination position of the motor vehicle and the output means for outputting the map path, the current map position of the motor vehicle and the shortest driving route to the destination position.

The system for route planning (route computation unit) 270 determines a shortest route to the destination position using the input destination position, the map path, the current position of the motor vehicle and the current map position of the motor vehicle 100.

It should be pointed out that an optimum route can also be determined in relation to a different criterion, for example a driving time.

The system for maneuver generation and maneuver navigation 271 generates instructions for the driver, referred to as maneuver instructions or maneuver information, which guide the driver along the planned route to the destination point.

The display unit 280 of the navigation system 200 is furthermore set up such that the driver of the motor vehicle 100 is shown acoustically and optically the shortest route (or other optimum) route to the input destination position.

The system for maneuver generation and maneuver navigation 271 is described in detail below.

Basic principles and design of the system for maneuver generation and maneuver navigation 271

As well as determining the position and planning/computing the route from the starting point to the travel destination, a navigation system must guide the driver along the route. The instructions or maneuvers used for this purpose are communicated to the driver visually in the form of arrows and bar charts and by means of a voice output.

The approach described for the system for maneuver generation and maneuver navigation 271 is based on fuzzy logic and consequently offers the advantage that it enables softer (system state) transitions than is the case with Boolean logic.

The fuzzy approach is, furthermore,—given appropriate parameterization—tolerant or robust against inaccuracies in the available data, such as directional data or change-of-direction data.

In addition, fuzzy logic approximates to the linguistic mode of expression of humans so that all in all more readily understandable maneuvers can be generated.

The fuzzy approach described below comprises two variants, a basic approach with maneuver generation using fuzzy logic and an (alternative) extended approach with maneuver generation using a rule-based fuzzy system.

The extended rule-based approach differs from the basic fuzzy-logic approach only insofar as additional route information, for example alternative routes, is included in the generation of maneuvers. The basic design of the extended rule-based approach corresponds otherwise to the basic fuzzy-logic approach.

Maneuver generation with fuzzy logic (Basic fuzzy-logic approach)

For generating maneuvers in motor vehicle navigation systems, a use of fuzzy-logic-based algorithms presents itself. In contrast to the Boolean logic used in the past, an approach based on fuzzy logic offers the advantage of making set membership mathematically describable by means of intermediate values between false (0) and true (1).

In addition to a numerical or quantitative description by means of matches, a qualitative description with fuzzy concepts of human thought is used to represent a problem, in this case the determination of maneuver information. These descriptions make it possible to handle nonfuzzy/crisp and fuzzy data formally precisely.

In addition, where there is a change in fuzzy rules, linguistic variables or operators, the reference to an overall behavior is retained. Specific and individual adjustments to possibly changing boundary conditions can thus be made easily and flexibly.

Furthermore, fuzzy logic approximates to linguistic mode of expression in humans, thus making possible maneuver information that is understandable overall.

According to the fuzzy approach of the system for maneuver generation and maneuver navigation 271, a previously used Boolean angle classification 300 of “orientation slots” 301 (FIG. 3) is replaced by a fuzzy angle classification 400 for route-direction changes (FIG. 4 voice output and FIG. 5 display output).

Soft transitions for the angle windows 401 are produced by the fuzzy angle classification 400 used for the route direction changes. There are no longer hard limits as in the case of the previous transitions between (0) and (1). With the exception of the unique points 0°, 90°, 180° and 270°, at least two membership functions 402 are always active.

The curves of the membership functions 402 are arranged through the use in sections of linear functions 403, in this case through simple triangular and trapezoidal functions, so that only interpolation points 404 are needed between which a linear interpolation is made.

The interpolation points 404 are the parameters of the membership functions 402 with which the individual curves can be customized to a user.

When setting the membership functions 403, particular consideration is also given to the priority which a maneuver possesses:
The three primary maneuvers (Straight, S) 410, (Left, L) 411, and (Right, R) 412 each have a high priority (i.e. a high maximum value of the membership function) and a large area of influence characterized by a large range of angles in which the value of the membership function is greatest. The priority of each of the secondary maneuvers (Hard Left, HL) 420, (Hard Right, HR) 421, (Soft Left, SL) 423 and (Soft Right, SR) 424 is lower.
The turning maneuver (U-Turn, U) 430 has a high priority, but only close to 180°.
The addition Hard H− has a medium priority since the membership function does not take on the value 1000. The area of influence is relatively large but smaller than is the case with the three primary maneuvers.

The addition Soft S− has a low priority as can be seen from the flat curve of the corresponding membership functions. Indeed, for the voice output (FIG. 4) the following applies: μ_{SR}<Max{μ_{S},μ_{R}} or μ_{SL}<Max{μ_{S},μ_{L}}, where μ(φ) describes a probability for a route direction change described by an angle φ. In the voice output, the addition soft is used only if at least one of the maneuvers S, R or L is already being used.

With the voice output, this procedure largely avoids use of the addition Soft S− or slight. A typical example is an intersection at which two streets lie within the angle window (Straight, S). This conflict was previously resolved such that each of the two streets was assigned the neighboring maneuver (Soft Right, SR or Soft Left, SL). This conflict no longer arises with the fuzzy angle classification, i.e. one street is given the maneuver (Straight, S) and the other the maneuver (Soft Right, SR or Soft Left, SL).

In addition to the fuzzy angle classification which is directly connected to membership values, a further evaluation variable is additionally introduced (FIG. 6) for selecting a fuzzy maneuver.

This further variable describes a significance or certainty S_{m,i} of a maneuver and is produced from the quotient of the match of the maneuver under consideration μ_{m,i} for a street i and the sum of the membership values with regard to the maneuver m:

$${S}_{m , i} = \frac{{μ}_{m , i}}{{\sum }_{j = 1}^{N} {μ}_{m , j}} \\ with m ∈ \{ S , SR , R , HR , U , HL , L , SL \} . \qquad ( Equation . 1 )$$

This value for the certainty simplifies the selection of an understandable maneuver. A value of 53% is chosen as a threshold value upward of which the certainty of a maneuver is guaranteed.

This value, which lies just above the limiting value 50%, guarantees an adequate gap between the maneuver with the greatest membership value relative to the other maneuvers.

FIG. 6 shows schematically the selection of a maneuver using the significance.

The selection of the fuzzy maneuver proceeds such (FIG. 6) that initially the maneuver with the greatest membership value μmax is specified. Only if this maneuver seems insufficiently certain, i.e. if the certainty is less than 53%, is the maneuver with the second highest membership value specified. In this way, use of the maneuver addition Soft S− is avoided.

Only if the certainty of this maneuver is also too low, is the maneuver specified which has the highest certainty.

If the maneuver found in this way is not clear, i.e. the value of the certainty is less than 50%, the fuzzy module is abandoned and a maneuver generated with the previous Boolean algorithms is accessed.

FIG. 13 shows schematically a process sequence 1300 in the generation of a maneuver with fuzzy logic (basic fuzzy logic approach).

In the generation of the maneuver with fuzzy logic, primary route information, which describes a primary route of the mobile unit, in this case the change of direction of the route, is determined 1310.

The primary route information is then evaluated using fuzzy logic, whereby the maneuver information item is determined 1320, 1330.

In the fuzzy evaluation, first memberships are determined 1320 for the primary route information using fuzzy membership functions, with which first memberships the membership of the primary route information of one of the predeterminable maneuver information items is described in each case.

In addition, the first memberships are evaluated using rules, whereby the maneuver information item is determined 1330,

Maneuver Generation with a Rule-Based Fuzzy System (Extended Rule-Based Approach)

In the case of the rule-based fuzzy system, fuzzification, inference and defuzzification are carried out, ensuring traceability of maneuver generation.

The generation of maneuvers is mapped on fuzzy rules which are compiled in a rule base (FIGS. 11 and 12). Based on the rule base, the facility also exists for adapting the system and the maneuver information resulting from it to a particular user.

Selection of input and output variables

The following are selected as input variables for the rule-based system:
a. The angle (change of direction of route) of the computed route (R) in [degrees].
b. The angle (change of direction of route) of the left neighbor of the route (NL) in [degrees].
c. The angle (change of direction of route) of the right neighbor of the route (NR) in [degrees].
d. Course (change of direction of route) of the main street (MS).

The following are selected as output variables:
a. The resulting maneuver for display (MD).
b. The resulting maneuver for voice (MV)

The basic sets G, which contain the range of values of the individual linguistic variables, are defined here as:
G_{R}={R,0°≦R≦360°}
G_{NL}={NL,0°≦NL≦360°}
G_{NR}={NR,0°≦NR≦360°}
G_{MD}={MD,0≦MD≦10}
G_{MV}={MV,0≦MV≦10}

In the case of main street recognition, no fuzzification takes place. Only the bit-pattern generated (see generation of rule base) is used for selecting the active rules from the rule base.

Design of Membership Functions

In rule-based maneuver generation by means of a rule-based fuzzy system, the curves of the membership functions are arranged through the use in sections of linear functions, in this case simple triangular and trapezoidal functions (cf. FIG. 4 and FIG. 5).

These section-wise linear membership functions have the advantage of being describable through the specification of few salient points. Consequently, the computational and storage outlay can be kept small. This allows, in subsequent fuzzification, i.e. in the conversion of crisp input values of the route, of the left and of the right neighbors into fuzzy membership values, a simple calculation of the membership values through interpolation between interpolation points.

By means of additional interpolation points between which linear interpolation is carried out, the membership functions can be adapted to circumstances.

The interpolation points also form the parameters with which the individual curves of the membership functions can be adapted to the particular user concerned.

The adaptations of the system to the particular user concerned, i.e. the adaptation of maneuvers, occurs in practical use of the navigation system.

In the adjustment of membership functions, particular consideration is given to a slight adaptability of the functions:
All functions used have equally high priority (the highest membership value is 1 in each case).
The maneuvers S, R, L, HR, and HL have a large area of influence (large range of angles in which the value of the membership function is highest).
The addition Soft, S− and the addition Hard, H− are used only rarely.
For each change of angle, the sum of membership values equals the value 1000.

The fuzzy sets are selected such that fuzzy sets adjacent to one another overlap to a greater or lesser extent, as a result of which a crisp input value can belong to several fuzzy sets simultaneously.

Design of the Linguistic Rules—Generation of the Rule Base (FIG. 11 and FIG. 12)

The design of the rule base constitutes an important step since the rules established here ultimately represent the rule strategy and thus the ‘intelligence’ of the fuzzy system.

The total number of possible rules depends on the number of input variables and on the set of linguistic terms per variable:

Where there are two input variables, each with two linguistic terms, the rule base can consist of a maximum of four rules. Where there are 4 input variables i=1, . . . , 4 (for route, left and right neighbor, main street) and Eᵢ as the set of linguistic terms, the rule base to be created here can contain a maximum of 1792 different rules (see Equation 2).
rₘₐₓ=E₁·E₂·E₃·E₄=7·8·8·4=1792 (Equation 2)

This relationship makes it immediately clear that where there are more than two input variables the total input space can generally no longer be exhausted. Nor is this usually at all necessary, since in operation of the navigation system in reality only some of all the possible combinations of input variable terms actually occur.

Moreover, the processing speed of the fuzzy system is substantially influenced by the size of the rule base. It is therefore advisable when designing the rule base to begin with a small number of rules. Rules can then gradually be added or the existing rules modified (e.g. combining of rules where they overlap) until the required quality of rules is achieved. In order to be able to assess the consistency of the rules, the individual rules of the rule base are shown graphically (FIG. 12).

In this way, contradictory rules can quickly be identified and removed. Also, the rule base is organized according to the bit-pattern of the route. FIGS. 11 (tabular) and 12 (graphic) show a representation of extracts from the rule base.

In order to ensure the coverage of all possible cases by the rule base, an instruction is added to the inference mechanism for cases where no rule is active.

In this case, the direction of the route is output as the default value.

In general, the rule base presents itself in the following form:

Rule 1:
IF r=A₁ₖ . . . AND ln=A₁₁ . . . AND
rn=A₁ₘ . . . AND ms=A₁ₙ
THEN disp=B₁ₚ . . . AND voice=B_{1q} (Equation 3)
. . .
Rule z:
IF r=A_{zk} . . . AND ln=A_{z1} . . . AND
rn=A_{zm} . . . AND ms=A_{zn}
THEN disp=B_{zp} . . . AND voice=B_{zq} (Equation 4)
with:
r, in, rn, ms: input variables
A₁₁, A₂₁, . . . , A_{z1}: bit-patterns of the input variable in
disp, voice: output variables
B₁ₚ, B₂ₚ, . . . , B_{zp}: bit-patterns of the output variable disp.
Inference Mechanism

With the inference mechanism, the rule base is evaluated and an overall decision reached by combining the subdecisions of the individual rules.

In order to specify the active rules, the bit-patterns specified after fuzzification (from the membership values of the individual linguistic variables, and main street recognition) are used.

A rule is deemed active if the bit-patterns created match wholly or in part the bit-pattern stored in the rule base. The performance value Pvᵢ of an active rule is produced by means of the following quotient:

$${Pv}_{i} = \frac{{\sum }_{a = 1}^{A} {μ}_{{next\_route}_{a}} \cdot {\sum }_{b = 1}^{B} {μ}_{{next\_left}_{b}} \cdot {\sum }_{c = 1}^{C} {μ}_{{next\_right}_{c}}}{{μ}_{max}^{2}} \qquad ( Equation 5 )$$

$${\sum }_{a = 1}^{A} {μ}_{{next\_route}_{a}} \text{:} sum of active membership values of the route .$$

sum of active membership values of the route.

$${\sum }_{b = 1}^{B} {μ}_{{next\_left}_{b}} \text{:} sum of active membership values of the left neighbor$$

sum of active membership values of the left neighbor

$${\sum }_{c = 1}^{C} {μ}_{{next\_right}_{c}} \text{:} sum of active membership values of the right neighbor .$$

sum of active membership values of the right neighbor.
μₘₐₓ²: maximum occurring possibilities (here: μₘₐₓ=1000).
i: sequential index of the particular rule concerned (here: i=0, . . . , n)
a=1, . . . , A: summation index (analogous applies to b and c)
A,B,CεN: upper summation limits (number of active membership values).

To determine the individual output fuzzy sets, the performance value of an active rule is then assigned to the output sets. The fuzzy sets of the conclusion of each active rule are cut off at the level of the respective performance value (Pvᵢ) of each rule. The fuzzy sets determined in the preceding step are then combined by addition into a resulting output fuzzy set.

Defuzzification: Maximum Method

The results of the inference are initially two resulting fuzzy sets for the output variables display and voice. In order to obtain crisp output variables which can be assigned to the appropriate maneuvers, the resulting output fuzzy sets must be defuzzified. The method which is used in this case is the maximum method. Here only the particular linguistic term of the output variable which has the highest accumulated performance value is considered. The assignment of the maneuver is carried out in accordance with this linguistic term. FIG. 14 represents schematically (in abstract) and FIG. 8 (in detail) a process sequence 1400 or 800 in the generation of maneuvers with a rule-based fuzzy system (extended rule-based approach).

In the rule-based generation of maneuvers, primary route information, which describes a primary route of the mobile unit, and at least one secondary route information item, which describes an alternative route to the primary route of the mobile unit, are determined 1410 or 810.

The primary route information and the secondary route information are evaluated using fuzzy logic, whereby the maneuver information item is determined 1420 to 1440 or 820 to 870.

In the fuzzy evaluation, first memberships are determined 1420 or 820 for the primary route information using fuzzy membership functions, with which first memberships the membership of the primary route information of one of the predeterminable maneuver information items is described in each case. For the secondary route information, second memberships are determined 1430 or 830 using fuzzy membership functions, with which second memberships the membership of the secondary route information of one of the predeterminable maneuver information items is described in each case.

The first and the second memberships are evaluated using fuzzy rules, whereby the maneuver information item is determined 1440 or 840 to 870.

Mode of functioning and of operation of the rule-based maneuver generation based on a (sample given) intersection situation.

Further explanatory comments on the mode of functioning and operation of rule-based maneuver generation based on a (sample given) intersection situation are given below.

The following explanatory comments are based upon the intersection situation shown by way of example in FIG. 9.

An appropriate maneuver is to be generated for the display and voice output for the intersection situation shown in FIG. 9.

In accordance with the rule-based generation of maneuvers, maneuver generation consists of the three components: fuzzification (a), inference mechanism (b) and defuzzification (c).

a) Fuzzification—Conversion of Crisp Input Values into Fuzzy Membership Values:

Through interpolation of the membership functions depending on the angle changes determined, the individual membership values are specified for the route 910 or 1010, the left neighbor 920 or 1020 and the right neighbor 930 or 1030 (FIG. 9, FIG. 10). These membership values indicate the extent to which the linguistic statements are satisfied.

The membership values are then stored for each angle in accordance with their match with the maneuver slots (Table 1).

From the computed membership values a corresponding bit-pattern is then formed (Table 1: In positions with a membership value greater than zero there is a 1 in the bit-pattern, otherwise a 0). This bit-pattern is needed in the selection of the active rules from the rule base.

In addition, when the active rules are specified, a value is generated for activating the intersection zoom to give an enlarged display of the intersection area to be driven through.

Recognition of the Main Street Situation:

Since no information or only very unsatisfactory information is available in relation to the course of main streets, streets are classified by rank and class.

Based on some set rules an analysis is then made of the current street situation. Here the course of the main street is determined from the values of street class and street rank, and the result of this analysis stored for further processing in the form of a bit-pattern.

A street is then recognized as a main street if:
The rank remains the same from entry to exit segment.
The class of the potential main street switches only between 2 and 3 or between 1 and 2 from entry to exit segment.
The class of the potential main street lies between 0 and 3.
The classes of all outgoing streets are lower than that of the potential main street (up to class 7, but classes 5 and 6 are exempted).

All outgoing streets have a lower rank.

TABLE 1
Membership values and the resulting bit-pattern
sorted by (SR, R, HR, N, HL, L, SL, S).

| | membership values | bit-pattern |
|---|---|---|
| route | (0, 0, 0, 0, 0, 0, 180, 820) | (0, 0, 0, 0, 0, 0, 1, 1) |
| left | (0, 0, 0, 0, 600, 400, 0, 0) | (0, 0, 0, 0, 1, 1, 0, 0) |
| neighbor | | |
| right | (700, 300, 0, 0, 0, 0, 0, 0) | (1, 1, 0, 0, 0, 0, 0, 0) |
| neighbor | | |

The following options are available here as alternatives for describing the course of the main street:
The route is itself the main street→R
The left neighbor of the route is the main street→LN
The right neighbor of the route is the main street→RN
No main street could be recognized→N

Applied to the intersection situation (FIG. 9), it turns out that with the appropriate street classes and street ranks in accordance with Table 2, no main street is recognized as running here. The main street recognition therefore returns→N as a feedback value here.

If the relevant bit-pattern is converted, this consequently gives: (0, 0, 0, 0, 1, 0, 0, 0,) sorted according to (X, X, X, X, N, RN, LN, R).

TABLE 2
Street class and rank.

| | entry | exit | left | right |
|---|---|---|---|---|
| | segment | segment | neighbor | neighbor |
| Class | 7 | 7 | 7 | 3 |
| Rank | 0 | 0 | 0 | 0 |

b) Inference—Specification of Active Rules

The aim of the evaluation of the rule base is to arrive at an overall decision by combining the subdecisions of the individual rules. By comparing the bit-patterns created with the rules filed in the rule base, the active rules for the current situation are obtained (Table 3).

A rule is deemed active for the current situation if the bit-patterns created match wholly or in part the bit-patterns stored in the rule base.

If one of the rules is recognized as active, then the performance value Pvᵢ of the rule is calculated in compliance with Equation 5.

The performance value is, like the membership value, restricted to values from the interval between 0 and 1000. Fractional digits are removed

$$\begin{matrix}e . g . Rule 9 \text{:} & {Pv}_{9} = \frac{180 \cdot 400 \cdot 300}{{10}^{6}}\end{matrix} = 21.6 or 21$$

The at this point exact performance value 21 cuts down the fuzzy sets of the conclusion of the active rule (cf. FIG. 7) at its level.

An analogous result is produced for the other active rules (Table 4).

By means of addition, the individual fuzzy sets are combined into an output fuzzy set (see last line in Table 4).

TABLE 3
Active rules

| Rule | | left | right | main | mnver | mnvr |
|---|---|---|---|---|---|---|
| index | route | neighbor | neighbor | street | display | voice |
| 0 | S | HL/L | SR/R | N/RN | S/N | S/N |
| 8 | SL | HL/L | SR | N | SL | SL/S |
| 9 | SL | L | R/HR/N | N/RN | SL | SL/S |
| 10 | SL | N/HL | SR/S | N/RN | SL | KL/L |
| 11 | SL | N/HL | R/HR/N | N | SL | L/S |

TABLE 4
Computed values for display and voice, sorted
by (S, SL, L, HL, N, HR, R, SR, KR, KL, C).

| rule | | | |
|---|---|---|---|
| index | Pνᵢ | display | voice |
| 0 | 820 | (820, 0, 0, 0, 820, | (820, 0, 0, 0, 820, 0, |
| | | 0, 0, 0, 0, 0, 0) | 0, 0, 0, 0, 0) |
| 8 | 126 | (0, 126, 0, 0, 0, 0, | (126, 126, 0, 0, 0, 0, |
| | | 0, 0, 0, 0, 0) | 0, 0, 0, 0, 0) |
| 9 | 21 | (0, 21, 0, 0, 0, 0, | (21, 21, 0, 0, 0, 0, 0, |
| | | 0, 0, 0, 0, 0) | 0, 0, 0, 0) |
| 10 | 75 | (0, 75, 0, 0, 0, 0, | (0, 0, 75, 0, 0, 0, 0, |
| | | 0, 0, 0, 0, 0) | 0, 75, 0, 0) |
| 11 | 32 | (0, 32, 0, 0, 0, 0, | (0, 0, 32, 0, 0, 0, 0, |
| | | 0, 0, 0, 0, 0) | 0, 0, 0, 0) |
| All | Total | (820, 252, 0, 0, 820, | (967, 147, 105, 0, 820, |
| | | 0, 0, 0, 0, 0, 0) | 0, 0, 0, 75, 0, 0) |

d) Defuzzification—Specification of a Crisp Output Value:

In compliance with the linguistic term of the output variable which has the highest totaled performance value, (here 967), the maneuver to be output is obtained via the output fuzzy set thus created.

The following publications are cited in this document:
[1] Zhao Yilin: “Vehicle Location and Navigation Systems”, Artech House Publishers, pp. 43-141, pp. 239-264, 1997, ISBN 0-89006-8621-5.
[2] Zhao Yilin: “Vehicle Location and Navigation Systems”, Artech House Publishers, pp. 129-141, 1997, ISBN 0-89006-8621-5.
[3] U.S. Pat. No. 4,796,191.
[4] Bart Kosko: “Neural Networks and Fuzzy Systems”, Prentice Hall, Ch. 7 & 8, 1992, ISBN 0-13611-435-0.

1. A method for determining maneuver information from a record of predeterminable maneuver information for a mobile unit using fuzzy logic,
wherein primary route information, which describes a primary route of the mobile unit, is determined,
wherein the primary route information is evaluated using fuzzy logic, whereby the maneuver information item is determined such that
a) first memberships are determined for the primary route information using fuzzy membership functions, with which first memberships the membership of the primary route information item of one of the predeterminable maneuver information items is described in each case,
b) and the first memberships are evaluated using rules, whereby the maneuver information item is determined.

2. A method for determining maneuver information from a record of predeterminable maneuver information for a mobile unit using fuzzy logic
wherein primary route information, which describes a primary route of the mobile unit, and at least one secondary route information item, which describes an alternative route to the primary route of the mobile unit, are determined,
wherein the primary route information and the secondary route information are evaluated using fuzzy logic, whereby the maneuver information item is determined such that
a) first memberships are determined for the primary route information using fuzzy membership functions, with which first memberships the membership of the primary route information item of one of the predeterminable maneuver information items is described in each case,
b) second memberships are determined for the secondary route information using fuzzy membership functions, with which second memberships the membership of the secondary route information item of one of the predeterminable maneuver information items is described in each case, and
c) the first and the second memberships are evaluated using fuzzy rules, whereby the maneuver information item is determined.

3. A method according to claim 1 or claim 2,
wherein the primary route information describes a route to be covered by the mobile unit and/or the secondary route information describes a route which can be covered as an alternative to the route to be covered.

4. A method according to any one of the preceding claims, wherein the primary route information and/or the secondary route information is/are described by a direction change, in particular by an angle of direction change.

5. A method according to any one of the preceding claims, wherein the primary route information and/or the secondary route information is/are determined using a digital map containing routes.

6. A method according to any one of the preceding claims, wherein the maneuver information item determined is output to a user by means of at least one of the following types of output:
an optical display of the maneuver information item determined,
an acoustic output of the maneuver information item determined.

7. A method according to any one of the preceding claims, wherein the fuzzy membership functions and/or the fuzzy rules are adapted to a type of output of the maneuver information item determined.

8. A method according to any one of the preceding claims,
wherein, in carrying out the evaluation using fuzzy logic, a significance is determined for one of the predeterminable maneuver information items, which significance describes a certainty for this predeterminable maneuver information item.

9. A method according to claim 8,
wherein this predeterminable maneuver information item is evaluated using the significance.

10. A method according to any one of the preceding claims,
wherein the first and/or second memberships are in each case coded as a bit-pattern.

11. A method according to any one of the preceding claims,
wherein a rule base is created which comprises fuzzy rules selected from the fuzzy rules.

12. A method according to any one of the preceding claims,
wherein a performance value is determined for a fuzzy rule, with which performance value a degree of performance of a rule result of the fuzzy rules is described.

13. A method according to claim 12,
wherein the performance value is determined for each of several fuzzy rules and the performance values are combined into an overall performance value.

14. A method according to claim 13,
wherein the maneuver information item is determined using the overall performance value.

15. A method according to any one of the preceding claims, used in a navigation system, in particular in a navigation system for a motor vehicle, wherein the mobile unit is the motor vehicle.

16. An arrangement for determining maneuver information from a record of predeterminable maneuver information for a mobile unit using fuzzy logic, comprising a processor which is set up for implementing the following steps:
wherein primary route information which describes a primary route of the mobile unit, and at least one secondary information item which describes an alternative route to the primary route of the mobile unit, are determined,
wherein the primary route information and the secondary route information are evaluated using fuzzy logic, whereby the maneuver information item is determined such that
a) first memberships are determined for the primary route information using fuzzy membership functions, with which first memberships the membership of the primary route information item of one of the predeterminable maneuver information items is described in each case,
b) second memberships are determined for the secondary route information using fuzzy membership functions, with which second memberships the membership of the secondary route information item of one of the predeterminable maneuver information items is described in each case, and
c) the first and the second memberships are evaluated using fuzzy rules, whereby the maneuver information item is determined.

17. A computer program with program-code means in order to implement all the steps according to claim 1 or claim 2 if the program is executed on a computer.

18. A computer program with program-code means according to claim 17, which program-code means are stored on a computer-readable data medium

19. A computer-program product with program-code means stored on a machine-readable medium, in order to implement all the steps according to claim 1 or claim 2 if the program is executed on a computer.

20. A method for determining maneuver information from a record of predeterminable maneuver information for a mobile unit using fuzzy logic,
wherein primary route information, which describes a primary route of the mobile unit, and at least one secondary route information item, which describes an alternative route to the primary route of the mobile unit, are determined,
wherein the primary route information and the secondary route information are evaluated using fuzzy logic, whereby the maneuver information item is determined such that
a) first memberships are determined for the primary route information using fuzzy membership functions, with which first memberships the membership of the primary route information item of one of the predeterminable maneuver information items is described in each case,
b) second memberships are determined for the secondary route information using fuzzy membership functions, with which second memberships the membership of the secondary route information item of one of the predeterminable maneuver information items is described in each case, and
c) the first and the second memberships are evaluated using fuzzy rules, whereby the maneuver information item is determined.

21. A method according to claim 1,
wherein the primary route information describes a route to be covered by the mobile unit and/or the secondary route information describes a route which can be covered as an alternative to the route to be covered.

22. A method according to any one of the preceding claims,
wherein the primary route information and/or the secondary route information is/are described by a change of direction, in particular by an angle of change of direction.

23. A method according to any one of the preceding claims,
wherein the primary route information and/or the secondary route information is/are determined using a digital map containing routes.

24. A method according to any one of the preceding claims,
wherein the maneuver information item determined is output to a user by means of at least one of the following types of output:
an optical display of the maneuver information item determined,
an acoustic output of the maneuver information item determined.

25. A method according to any one of the preceding claims,
wherein the fuzzy membership functions and/or the fuzzy rules are adapted to a type of output of the maneuver information item determined.

26. A method according to any one of the preceding claims,
wherein, in carrying out the evaluation using fuzzy logic, a significance is determined for one of the predeterminable maneuver information items, which significance describes a certainty in respect of this one predeterminable maneuver information item.

27. A method according to claim 7,
wherein this predeterminable maneuver information item is evaluated using the significance.

28. A method according to any one of the preceding claims,
wherein the first and/or second memberships are each coded as a bit-pattern.

29. A method according to any one of the preceding claims,
wherein a rule base is created which comprises fuzzy rules selected from the fuzzy rules.

30. A method according to any one of the preceding claims,
wherein a performance value is determined for a fuzzy rule, with which performance value a degree of performance of a rule result of the fuzzy rules is described.

31. A method according to claim 11,
wherein the performance value is determined for each of several fuzzy rules and the performance values are combined into an overall performance value.

32. A method according to claim 12,
wherein the maneuver information item is determined using the overall performance value.

33. A method according to any one of the preceding claims,
used in a navigation system, in particular in a navigation system for a motor vehicle, wherein the mobile unit is the motor vehicle.

34. An arrangement for determining maneuver information from a record of predeterminable maneuver information for a mobile unit using fuzzy logic, comprising a processor which is set up for implementing the following steps:
i. wherein primary route information which describes a primary route of the mobile unit, and at least one secondary information item which describes an alternative route to the primary route of the mobile unit, are determined,
ii. wherein the primary route information and the secondary route information are evaluated using fuzzy logic, whereby the maneuver information item is determined such that
a) first memberships are determined for the primary route information using fuzzy membership functions, with which first memberships the membership of the primary route information item of one of the predeterminable maneuver information items is described in each case,
b) second memberships are determined for the secondary route information using fuzzy membership functions, with which second memberships the membership of the secondary route information item of one of the predeterminable maneuver information items is described in each case, and
c) the first and the second memberships are evaluated using fuzzy rules, whereby the maneuver information item is determined.

35. A computer program with program-code means in order to implement all the steps according to claim 1 if the program is executed on a computer.

36. A computer program with program-code means according to claim 16, which program-code means are stored on a computer-readable data medium.

37. A computer-program product with program-code means stored on a machine-readable medium, in order to implement all the steps according to claim 1 if the program is executed on a computer.
